(19) United States
(12) Patent Application Publication
(10) Pub. No.: US 2026/0184113 A1
(43) Pub. Date: Jul. 2, 2026

(54) PNEUMATIC VEHICLE TYRE AND METHOD FOR PRODUCING A PNEUMATIC VEHICLE TYRE

(71) Applicant: Continental Reifen Deutschland GmbH, Hannover (DE)

(72) Inventor: Stephen Ronan, Garbsen (DE)

(73) Assignee: Continental Reifen Deutschland GmbH, Hannover (DE)

(21) Appl. No.: 18/868,205

(22) PCT Filed: May 15, 2023
(86) PCT No.: PCT/DE2023/200098

§ 371 Date: Nov. 22, 2024

(30) Foreign Application Priority Data
May 24, 2022 (DE) 10 2022 205 196.3

(51) Int. Cl. B60C 11/00

(52) U.S. Cl. CPC B60C 11/0008; B60C 2011/0016; B60C 2200/10

(57) ABSTRACT

A pneumatic vehicle tire including a tread having a width and with a central tread part of a first rubber material, running over part of the width of the tread, and a tread part of a second rubber material, adjoining the first part, forming lateral portions of the tread outer surface and running continuously over the entire width of the tread, the first rubber material having a Shore A hardness in accordance with DIN ISO 7619-1 that is greater than the Shore A hardness of the second rubber material. The tread part that runs over the entire width of the tread covers the central tread part radially on the outside and forms the complete outer surface of the tread.

The invention relates to a pneumatic vehicle tire comprising a tread having a width and with a central tread part of a first rubber material, running over part of the width of the tread, and a tread part of a second rubber material, adjoining the first part, forming lateral portions of the tread outer surface and running continuously over the entire width of the tread, the first rubber material having a Shore A hardness in accordance with DIN ISO 7619-1 that is greater than the Shore A hardness of the second rubber material.

The invention also relates to a method for producing such a pneumatic vehicle tire.

A pneumatic vehicle tire of the type mentioned at the beginning, which is a motorcycle tire, is known for example from WO 01/39998 A1. The motorcycle tire comprises a tread having a central tread part and a tread part that runs continuously over the entire width of the tread. The central tread part is “inserted” in the tread part that runs continuously over the entire width of the tread, with the result that the continuously running tread part runs radially inside the central tread part. The rubber material of the central tread part has a Shore A hardness at 100° C. of at least 50 ShA (Shore A). The rubber material of the tread part that runs continuously over the entire width of the tread has a Shore A hardness at 100° C. of 40 ShA to 49 ShA.

The invention is based on the object of designing a pneumatic vehicle tire of the type mentioned at the beginning in such a way that its tread is particularly balanced with regard to its gripping properties in the new state, while good driving comfort and good handling properties are intended to be maintained. A method for producing such a pneumatic vehicle tire is also to be provided, the manufacture of tread parts of variable cross-sectional form being intended to be possible.

As regards the pneumatic vehicle tire, the stated object is achieved according to the invention in that the tread part that runs over the entire width of the tread covers the central tread part radially on the outside and forms the complete outer surface of the tread.

As regards the method, the stated object is achieved in that the central tread part is formed by one-time winding of an extruded rubber compound and the tread part that runs over the entire width of the tread is formed by repeated spiral and overlapping winding of an extruded rubber compound strip.

The pneumatic vehicle tire, owing to the softer tread part that runs continuously over the outer surface of the tread, has particularly advantageous gripping properties and good handling properties. The harder central tread part, which is radially on the inside of this tread part, ensures good driving comfort.

The method according to the invention makes it possible to be able to modify the tread parts easily in terms of their cross-sectional form, with the result that a tire with the respective desired gripping and handling characteristics can be produced particularly economically.

According to one preferred embodiment, the Shore A hardness of the rubber material of the tread part that runs over the entire width of the tread is 50.0 ShA to 65.0 ShA, in particular 55.0 ShA to 63.0 ShA. This measure is particularly advantageous for optimum driving comfort.

A further, preferred embodiment is characterized in that the Shore A hardness of the rubber material of the central tread part is 3.0 ShA to 25.0 ShA, in particular up to 20.0 ShA, preferably up to 15.0 ShA, particularly preferably 8.0 ShA to 12.0 ShA greater than the Shore A hardness of the rubber material of the tread part that runs over the entire width of the tread. This measure ensures advantageous stabilization of the softer tread part in terms of the gripping and handling properties.

It is also preferred if the Shore A hardness of the rubber material of the central tread part is at most 75.0 ShA. This measure contributes in particular to maintaining good driving comfort as the wear of the tread progresses.

According to a further, preferred embodiment, the central tread part has a width of 30% to 85%, in particular 40% to 75% the width of the tread. As a result, even as the wear of the tread progresses in correspondingly wide lateral portions of the tread, the softer rubber material of the tread part that runs over the entire width of the tread when the tire is new is retained. This contributes to persistently good handling properties during cornering as the tread wears down.

With preference, the central tread part, as viewed in cross section, is symmetrical with respect to the equatorial plane of the tire.

According to a further, preferred embodiment, the central tread part, as viewed in cross section, in the radial direction at its thickest point has a thickness which is 50% to 90%, in particular 60% to 85% the thickness of the tread determined in the radial direction on the equatorial plane of the tire. This measure contributes to good driving comfort when the tire is new.

In the last-mentioned embodiment, it is advantageous if the central tread part has its thickest point at least in the equatorial plane of the tire.

A further, preferred embodiment is characterized in that the central tread part, as viewed in cross section, is circular segmental and tapers out toward the shoulders of the tread.

In an alternative and likewise preferred embodiment, the central tread part, as viewed in cross section, has a middle part with a width, determined in the axial direction, of 15% to 30% the width of the central tread part and two side parts that are thinner than the middle part and have end portions tapering out toward the shoulders of the tread. A central tread part designed in this way allows fine adjustment of the gripping properties, the driving comfort and the handling properties.

With preference, the pneumatic vehicle tire is a pneumatic vehicle tire for a single-track motor vehicle.

With particular preference, the pneumatic vehicle tire is a motorcycle tire. In particular ensured in the case of a motorcycle tire are good driving comfort and particularly good gripping and handling properties when cornering, even as the wear of the tread progresses.

A further, preferred embodiment is characterized in that the central tread part is produced from an extruded rubber compound and the tread part that runs over the entire width of the tread is produced from an extruded rubber compound strip that is repeatedly spirally and overlappingly wound. In the case of a tire formed in this way, the tread can be adapted particularly easily during the manufacture, as a result of which the tire can be configured particularly easily in terms of the desired gripping properties, the driving comfort and the handling properties.

Further features, advantages and details of the invention will now be discussed in more detail with reference to the drawing, which schematically shows exemplary embodiments of the invention. In the figures:

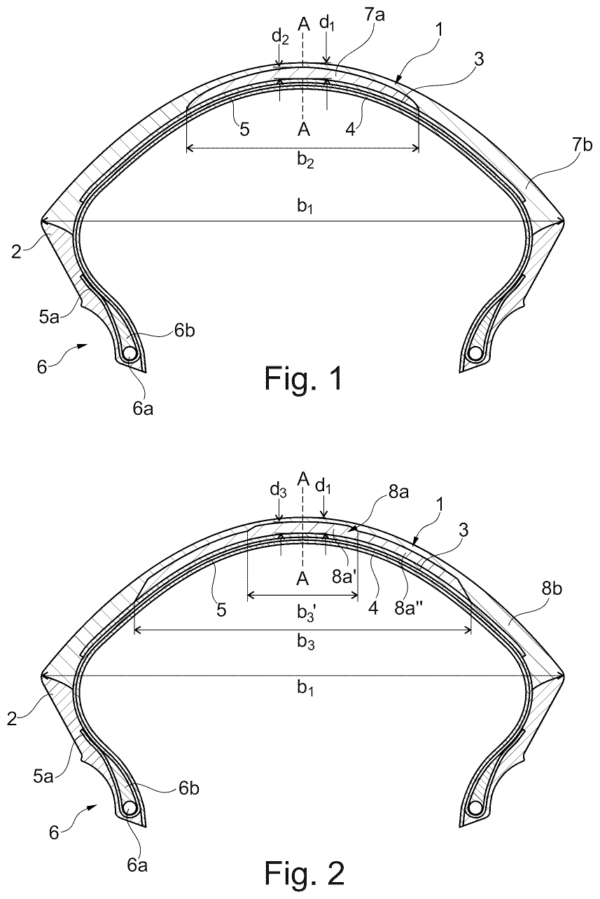

FIG. 1 shows a cross section through a motorcycle tire with a first embodiment variant of the invention and

FIG. 2 shows a cross section through a motorcycle tire with a second embodiment variant of the invention.

Pneumatic vehicle tires designed according to the invention are tires for motor vehicles, in particular for single-track motor vehicles, preferably for motorcycles, or for multi-track motor vehicles, in particular for passenger cars, vans or light trucks (small goods vehicles of GVW≤3.5 t, lightweight goods vehicles of GVW≤7.5 t).

FIG. 1 and FIG. 2 each show a cross section through a radial pneumatic vehicle tire for a motorcycle. The pneumatic vehicle tire has a tread 1, two sidewalls 2, a belt 3, an inner layer 4, a carcass ply 5 and bead regions 6 with a respective bead core 6a and a respective bead filler 6b. The equatorial plane of the tire is indicated by a respective line A-A.

The belt 3 has one or two plies, each ply consisting of reinforcing members embedded in a belt rubberizing compound and running parallel to one another, for example steel or textile cords of known construction.

The carcass ply 5 runs between the belt 3 and the inner layer 4 and between the sidewalls 2 and the inner layer 4 and is wrapped around the bead cores 6a, forming carcass turn-ups 5a. The carcass ply 5 consists of a carcass rubberizing compound and reinforcing members, which are embedded therein and in particular are also steel or textile cords of known construction.

The tread 1 is provided with a profiling, not shown and designed for example in the known way, and has, as viewed in cross section, a thickness d₁ determined in the equatorial plane of the tire and in the radial direction and a width b₁ determined perpendicularly to the equatorial plane of the tire. The thickness d₁ is determined between the belt 3 and the periphery of the tread. The periphery of the tread is defined by an envelope containing the outer surface of the tread. The width b₁ is measured between the furthest-apart points of the tread 1.

In the embodiments shown in FIG. 1 and FIG. 2, the tread 1 is composed in each case of a central tread part 7a (FIG. 1), 8a (FIG. 2), which runs over part of the width b₁, and a tread part 7b (FIG. 1), 8b (FIG. 2) that runs continuously over the entire width b₁. The tread part 7b, 8b laterally adjoins the central tread part 7a, 8a, covers the central tread part 7a, 8a radially on the outside and forms the complete outer surface of the tread when the tire is new.

In the embodiment according to FIG. 1, the central tread part 7a, as viewed in cross section, has a width b₂, determined perpendicularly to the equatorial plane of the tire, of 30% to 85%, in particular 35% to 45% the width b₁ of the tread 1 and also a thickness d₂, determined in the equatorial plane of the tire and in the radial direction, of 50% to 90%, in particular 60% to 85% the thickness d₁ of the tread 1 and is circular segmental, such that it tapers out toward the shoulders of the tread.

In the embodiment shown in FIG. 2, the central tread part 8a, as viewed in cross section, has a width b₃, determined perpendicularly to the equatorial plane of the tire, of 50% to 85%, in particular 60% to 70% the width b₁ of the tread 1 and also a thickness d₃, determined in the equatorial plane of the tire and in the radial direction, of 50% to 90%, in particular 60% to 85% the thickness d₁, the central tread part 8a having a middle part 8a′ and two side parts 8a″ that are thinner than the middle part and have a respective end portion (not provided with a reference number) tapering out toward the shoulder of the tread. The middle part 8a′, as viewed in cross section, has a width b₃′, with respect to the radially outer surface of the side parts 8a″, of 15% to 30% the width b₃.

The tread part 7b, 8b consists of a rubber material with a Shore A hardness in accordance with DIN ISO 7619-1 of 50.0 ShA to 65.0 ShA, in particular 55.0 ShA to 63.0 ShA.

The central tread part 7a, 8a consists of a rubber material with a Shore A hardness in accordance with DIN ISO 7619-1 which is 3.0 ShA to 25.0 ShA, in particular up to 20.0 ShA, preferably up to 15.0 ShA, particularly preferably 8.0 ShA to 12.0 ShA greater than the Shore A hardness of the rubber material of the tread part 7b. 8b.

It is also preferred if the rubber materials of the tread parts 7a, 7b, 8a, 8b are matched to one another such that the Shore A hardness of the rubber material of the central tread part 7a, 8a is at most 75.0 ShA.

The central tread part 7a, 8a is produced in a correspondingly profiled mold from an extruded rubber compound, which is placed onto the formed tire carcass or the formed belt when the tire is being produced. The tread part 7b, 8b is produced from an extruded rubber compound strip which, after the extruded rubber compound forming the central tread part 7a, 8b has been placed on, is repeatedly spirally and partially overlappingly wound (strip winding).

The invention is not limited to the exemplary embodiments described.

In particular, the tire can also be a tire for a passenger car, a van or a light truck.

### LIST OF REFERENCE SIGNS

1 . . . Tread
2 . . . Sidewall
3 . . . Belt
4 . . . Inner layer
5 . . . Carcass ply
5a . . . Carcass turn-up
6 . . . Bead region
6a . . . Bead core
6b . . . Bead filler
7a . . . Central tread part
7b . . . Tread part
8a . . . Central tread part
8a′ . . . Middle part
8a″ . . . Side part
8b . . . Tread part
A-A . . . Line (equatorial plane of the tire)
b₁, b₂, b₃, b₃′ . . . Width
d₁, d₂, d₃ . . . Thickness

1. A pneumatic vehicle tire comprising a tread having a width and with a central tread part of a first rubber material, running over part of the width of the tread, and a tread part of a second rubber material, adjoining the first part, forming lateral portions of the tread outer surface and running continuously over the entire width of the tread, the first rubber material having a Shore A hardness in accordance with DIN ISO 7619-1 that is greater than the Shore A hardness of the second rubber material,
wherein
the tread part that runs over the entire width of the tread covers the central tread part radially on the outside and forms the complete outer surface of the tread.

2. The pneumatic vehicle tire as claimed in claim 1, wherein the Shore A hardness of the rubber material of the tread part that runs over the entire width of the tread is 50.0 ShA to 65.0 ShA, in particular 55.0 ShA to 63.0 ShA.

3. The pneumatic vehicle tire as claimed in claim 1, wherein the Shore A hardness of the rubber material of the central tread part is 3.0 ShA to 25.0 ShA, in particular up to 20.0 ShA, preferably up to 15.0 ShA, particularly preferably 8.0 ShA to 12.0 ShA greater than the Shore A hardness of the rubber material of the tread part that runs over the entire width of the tread.

4. The pneumatic vehicle tire as claimed in claim 1, wherein the Shore A hardness of the rubber material of the central tread part is at most 75.0 ShA.

5. The pneumatic vehicle tire as claimed in claim 1, wherein the central tread part has a width of 30% to 85%, in particular 40% to 75% the width of the tread.

6. The pneumatic vehicle tire as claimed in claim 1, wherein the central tread part, as viewed in cross section, is symmetrical with respect to the equatorial plane of the tire.

7. The pneumatic vehicle tire as claimed in claim 1, wherein the central tread part, as viewed in cross section, in the radial direction at its thickest point has a thickness which is 50% to 90%, in particular 60% to 85% the thickness of the tread determined in the radial direction on the equatorial plane of the tire.

8. The pneumatic vehicle tire as claimed in claim 7, wherein the central tread part has its thickest point at least in the equatorial plane of the tire.

9. The pneumatic vehicle tire as claimed in claim 1, wherein the central tread part, as viewed in cross section, is circular segmental and tapers out toward the shoulders of the tread.

10. The pneumatic vehicle tire as claimed in claim 5, wherein the central tread part, as viewed in cross section, has a middle part with a width, determined in the axial direction, of 15% to 30% the width of the central tread part and two side parts that are thinner than the middle part and have end portions tapering out toward the shoulders of the tread.

11. The pneumatic vehicle tire as claimed in claim 1, which is a pneumatic vehicle tire for a single-track motor vehicle.

12. The pneumatic vehicle tire as claimed in claim 11, which is a motorcycle tire.

13. The pneumatic vehicle tire as claimed in claim 1, wherein the central tread part is produced from an extruded rubber compound and the tread part that runs over the entire width of the tread is produced from an extruded rubber compound strip that is repeatedly spirally and overlappingly wound.

14. A method for producing a pneumatic vehicle tire comprising a tread having a width and with a central tread part of a first rubber material, running over part of the width of the tread, and a tread part, of a second rubber material, adjoining the first part, forming lateral portions of the tread outer surface and running continuously over the entire width of the tread, the first rubber material having a Shore A hardness in accordance with DIN ISO 7619-1 that is greater than the Shore A hardness of the second rubber material,
wherein
the central tread part is formed by one-time winding of an extruded rubber compound and the tread part that runs over the entire width of the tread is formed by repeated spiral and overlapping winding of an extruded rubber compound strip.
